(19) United States
(12) Patent Application Publication
(10) Pub. No.: US 2010/0211394 A1
(43) Pub. Date: Aug. 19, 2010

(54) METHOD FOR DETERMINING A STRESS STATE OF A PERSON ACCORDING TO A VOICE AND A DEVICE FOR CARRYING OUT SAID METHOD

(76) Inventor: Andrey Evgenievich Nazdratenko, Vladivostok (RU)

Correspondence Address: DEFILLO & ASSOCIATES, INC., P.O. Box 14104, Clearwater, FL, 33766, US

(21) Appl. No.: 12/442,718

(22) PCT Filed: Oct. 3, 2006
(86) PCT No.: PCT/RU2006/000514

§ 371 Date: Mar. 25, 2009

(51) Int. Cl. G10L 21/00

(52) U.S. Cl. 704/270; 704/E21.001

(57) ABSTRACT

The invention relates to the field of methods and devices for analyzing of psychophysiological reactions of a person to verbal tests. The invented device (1) for carrying out the inventive method for determining a stress state comprises a receiving unit for receiving a voice signal, for example, from a microphone (5); a processing unit for determining a level of the stress state according to one dimensionless parameter based on spectral characteristics such as a base frequency, intensity, median and width of a spectrum; and a display unit for displaying a stress state, consisting, for example, a light-emitting device (6) or a device for generating vibrations (7), wherein a length of light wave or vibration frequency depends on the level of a stress state.

### CROSS REFERENCE TO RELATED APPLICATION

This application is a national stage of PCT/RU2006/000514 filed Oct. 3, 2006, under the International Convention.

### TECHNICAL FIELD

The invention relates to the field of methods and devices for analysis of psychophysiological reactions of a person to verbal tests and can be applied for medical purposes and in judicial practice, and also in day-to-day activities for making decisions.

### BACKGROUND ART

Various methods and devices for parametrization of a voice signal exposed to stress are known in prior art. Thus, it is known a device and a method for determining a person's subconscious excitements [patent publication WO 0062279, published 19 Oct. 2000]. The device contains an analog-to-digital converter connected with various voice sources as a telephone, a microphone or the Internet, a voice frequency spectrum analyzer, a demonstrator of revealed sound results such as a loudspeaker or visual results on a display in form a diagram, a graphical drawing or some illustration. The method incorporates digital computing an analog of a voice segment, analyzing computed values, revealing excitements in the voice analog of a speaking person and their indication to trace the revealed excitements. Disadvantage of the known method is insufficient aspect of accuracy of specific testing results in the analysis, an absence of guarantees of true identification of responses of a specific subject to tests, insufficient reliability of the conclusion about honesty of a person being tested when answering a question, which requires repeated confirmation by varying a form of the question.

Also it is known a method and a device for controlling an emotional state of a person [patent publication WO 9520216, published 27 Jul. 1995]. The method for controlling the emotional state incorporates detecting voice vibrations of a person, filtrating detected vibrations to receive residual signals, comparison of the residual signals to get a result, generalization of coincided back and forward residual signals in order to evaluate a voice vibration, revealing evaluations that exceed voice vibrations, and fixation of indications of some emotional state of the speaking person. The device for controlling the emotional state includes a voice detector, an inverse and reverse filter, a cross correlation meter of relations of residual signals, an integrator of maximal partially overlapping back and forward signals to evaluate voice vibrations, a processor for processing and measuring detected components of excitement, accumulation, fixation and analysing the emotional state of the person. Disadvantage of the known method is a doubtfulness of relevance of the used data and procedure of data processing, subjectivity of taken decisions because of a great share of statistical approach to taking a decision on honesty or dishonesty of the subject being tested, which increases a risk of an error fraught with a possible unreasonable accusation with dishonesty of the person being tested.

A device and a method for automatic classification of an affected component of a human speech is selected as a prototype [patent publication WO 9922364, published Jun. 5, 1999]. The device contains a unit for receiving, recording and analyzing a voice signal, a unit for measurement, computation and classification of its spectral characteristics, as well as a unit for displaying results of a stress state. The method incorporates receiving, recording and analyzing the voice signal to establish its significance and a value when revealing peculiarities, at least, of one characteristic, measurement, computation and classification of its spectral characteristics in time count located at least in two computed windows taken for statistical processing and insincerely sounded on a spectral scan, their classification and displaying results of a stress state. Disadvantage of the known device is its increased sensitivity to various disturbances, and insufficiently relevant selection and processing of initial parameters separated from a spectrum, which reduces reliability of obtained results.

### DISCLOSURE OF THE INVENTION

The technical problem to be solved is to increase reliability and accuracy of results of determining a stress state of a person based on spectral characteristics of a voice of the person by choosing the most relevant initial parameters from the spectral characteristics of the voice, as well as by using the most adequate model for the processing such initial parameters in order to compute stress on a basis of the proposed universal integral parameter.

It is proposed a method for determining a stress state of a person according to a voice including following steps: receiving a voice signal in a certain time interval; computation of spectral characteristics of the received voice signal; determining a level of a stress state according to the computed spectral characteristics; and displaying results of determined stress state. There are new features: when computing the spectral characteristics, at least four parameters of a spectrum of the received voice signal are computed: a base frequency, an intensity of the spectrum, a median of the spectrum and a width of the spectrum; when determining the level of a stress state, a dimensionless normalized stress parameter is computed for every of the four parameters, wherein said dimensionless normalized stress parameter shows the stress state for each of the parameters of the spectrum and is equal from 0 to 1, and the level of a stress state is determined as a weighted mean value of all computed normalized stress parameters.

In order to compute the spectral characteristics, it is better to use voice signal windows overlapping at least by a half of a width thereof.

In addition, the voice signal windows are taken for the computation in condition that there are not more than one non-vocalized voice signal window in a row of the taken voice signal windows, and/or when a relative deviation of the base frequency in any couple of vocalized voice signal windows does not exceed 20%.

When computing every of the normalized stress parameters, it is better preliminary compute a stress factor Z of the normalized stress parameter as a sum of relative deviations between an arithmetic mean value of the parameter and a current value of the parameter and between a local mean value of the parameter and the current value of the parameter, then a normalized stress parameter is computed as 1/(1+e^{Z})

In this case, it is better to take the base frequency at a maximum of the spectral characteristic within a frequency range of 50-500 Hz as a current value of the base frequency.

It is better to compute the intensity of the spectrum as an integral of a square of the spectral characteristic.

It is better when the median of the spectrum is computed as a weighted mean value of the spectral characteristic, wherein frequencies are used as weights.

It is better when the width of the spectrum is computed as a difference between maximum and minimum frequencies for which the spectral characteristic exceeds a preset threshold value, for example, by preliminary presetting the threshold value of 2-8%, below of which the spectral characteristic is considered as to be zero.

In the step of the determining a level of the stress state, it is better when the weighted mean value of all computed normalized stress parameters is determined as an arithmetic mean value thereof.

The results of the determined stress state can be displayed by optical emission in a range of visible waves wherein a length of an emitted light wave depends on a value of the determined level of a stress state.

In this case, the determined level of the stress state is displayed so that the length of the emitted light wave increases or decreases in increasing or decreasing the value of the determined level of a stress state in a range of possible values thereof. For example, a green light is used for the displaying minimal values of the level of a stress state, a yellow light is used for the displaying mean values of the level of a stress state, and a red light is used for the displaying the maximal values of the level of a stress state.

The results of the determined stress state can be displayed by vibration, wherein a frequency of the vibration depends on a value of the determined level of a stress state.

In this case, the determined level of the stress state is displayed so that the a frequency of the vibration increases or decreases up to zero in increasing or decreasing the value of the determined level of a stress state in a range of possible values thereof. For example, a minimal frequency of the vibration among possible values thereof or an absence of the vibration is used for the displaying minimal values of the level of a stress state, a mean frequency of the vibration among the possible values thereof is used for the displaying mean values of the level of a stress state, and a maximal frequency of the vibration among the possible values thereof is used for the displaying maximum values of the level of a stress state.

Also, it is proposed a device for determining a stress state of a person according to a voice including: a receiving unit for receiving a voice signal in a certain time interval; a processing unit for computation of spectral characteristics of a spectrum of the received voice signal converted into a digital form and determining a level of a stress state according to the computed spectral characteristics; and a display unit for displaying results of a determined stress state. New feature is that the processing unit is fulfilled with possibilities to compute the spectral characteristics of the spectrum of the received voice signal and to determine the level of a stress state according to the above-mentioned method.

The display unit can be carried out as an optical emission means for emitting a light in a range of visible waves, wherein a length of an emitting light wave depends on a value of the level of a stress state determined by the processing unit. For example, the optical emission means has possibility to emit a green light when the level of a stress state has minimal values among possible values of the level of a stress state, a yellow light for mean values among the possible values of the level of a stress state, and a red light for maximal values among possible values of the level of a stress state.

The display unit can be carried out as a vibration means, wherein a frequency of vibrations depends on the level of a stress state determined by the processing unit. For example, the vibration means has possibility to vibrate with a minimal frequency of a vibration up to zero among possible values thereof for the vibration means when the level of a stress state has minimal values among possible ones, to vibrate with mean frequencies of the vibrations among the possible values thereof for the vibration means when the level of a stress state has mean values of the possible values among possible ones, and to vibrate with maximal frequencies of the vibration among the possible values thereof for the vibration means when the level of a stress state has maximum values among possible ones.

All units of the device can be combined into a single portable device or incorporated into a computer or a computerized device selected from a group: a digital dictophone; a cellular telephone; a digital sound-recording camera; a palm-size computer.

### BRIEF DESCRIPTION OF THE DRAWINGS

The invention is described in detail by examples accompanying by following figures of drawings:

FIG. 1—a schematic block diagram of a device under the present invention;

FIG. 2—a simplified block diagram of basic steps of the proposed method;

FIG. 3—a view showing schematically one embodiment of the invention.

### THE BEST EXAMPLE FOR CARRYING OUT THE INVENTION

FIG. 1 shows a schematic block diagram of the device under the present invention.

As shown in FIG. 1, a device 1 for determining a person's stress state by a voice includes a receiving unit 2 for receiving a voice signal in a certain time interval, a processing unit 3 for computation of spectral characteristics of a spectrum of the received voice signal converted into a digital form and determining a level of a stress state according to computed spectral characteristics, and a display unit 4 for displaying results of the determined stress state.

All units 2-4 can be implemented as software-hardware of a computer or a computerized device.

The receiving unit 2 is intended for receiving a sample of the voice signal in a certain time interval in a digital form or an analog form with further conversion into a digital form for further processing data of the voice signal in the processing unit 3. As a sample of the voice signal, there can be used a voice signal in real-time mode or a segment of the voice signal within a some certain time interval stored in any of known tangible media. For example, as a voice signal, in the real-time mode, there can be used a voice signal from a microphone converted into a digital form by a computer sound card, a digital dictophone and others, and a voice signal received via various broadcasting networks (television, radio) including cable, wireless and other communication networks. In order to store a segment of the voice signal, there can be used any magnetic and optical information media, microprocessor-based data storage devices. It should be noted that a segment of the voice signal can be recorded and stored on a media in both a digital form and an analog form with further conversion thereof into the digital form in the receiving unit 2. Also it should be noted that a segment of the voice signal can be recorded and stored on a medium as an audio signal jointly with a video signal with further separating the audio signal and its conversion into the digital form when necessary. As the receiving unit 2, there can be used any software-hardware means that enable to receive into a computer or a computerized device the voice signal in a digital form or an analog form with further conversion into digital one, for example: sound cards, USB ports, wireless communication cards (radio, infrared, Bluetooth), disc drives for various discs (FD, CD, DVD) etc.

The processing unit 3 is intended for computing spectral characteristics of the voice signal received and converted into a digital form by the receiving unit 2, and for determining a level of a stress state according to computed spectral characteristics. The processing unit 3 can be implemented with using a central processor on a basis of any software-hardware tools of known computers or computerized devices, as well as a separate device with loaded with software embodying the proposed method under the present invention.

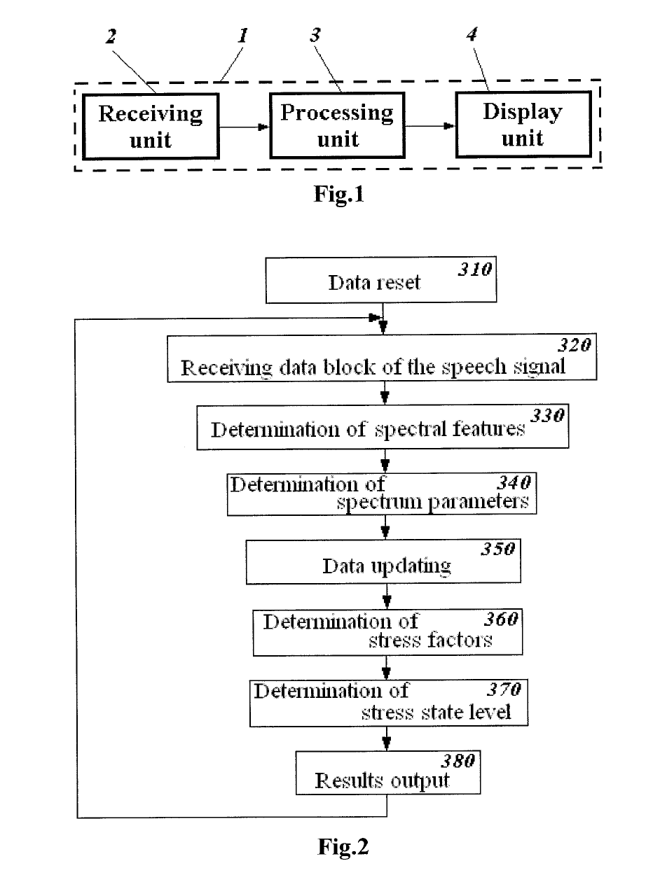

FIG. 2 presents a simplified block diagram of basic steps 310-380 of the proposed method which are processing by the processing unit 3 as described below.

Before starting, all previously received and computed data of a voice signal and parameters of spectral characteristics of a spectrum of the voice signal are reset (step 310). First, the processing unit 2 receives a data block of a voice signal in a digital form from the receiving unit 2 (step 320). The received data block is processed by obtaining spectral characteristics of the voice signal of this data block by any known common method (step 330).

In a course of extended studies, it was founded that following four initial parameters of a spectrum (i.e. the parameters derived by a direct computation from a spectrum) are the most relevant: a fundamental tone frequency or a base frequency (FTF), an intensity of the spectrum, a median of the spectrum and a width of the spectrum. That is, to determine a level of the stress state, it will suffice to use these four parameters with a high degree of accuracy of obtained results over 95%, as it will be further described.

When performing the step 340, the four above-mentioned parameters of the spectrum are computed from the obtained spectral characteristics.

When computing according to data of previously recorded and stored voice signal sample, computation is executed by using windows overlapping each other by a half of widths thereof. Thus, every time count belongs to two computed windows. However, when computing according to data in a real-time mode, the computation is executed by a last short time interval.

Frequency with a maximal spectral characteristic in a range of 50-500 Hz is taken as a current value of the FTF, provided that loudness of the voice signal is enough to consider this signal to be significant. But, it might be well to point that when computing according to the stored sample, a window is taken for the computation only when there is not more than one non-vocalized window together with the previous and more previous one, at that, a relative deviation of the FTF in any pair of vocalized windows should not exceed 20%. When computing in the real-time mode, this clause may be disregarded.

When computing the intensity of the spectrum, a commonly accepted notion of an intensity as an integral of a square of a spectral characteristic is used.

The median of the spectrum is computed as a sum of products of values of the spectral characteristic into relevant frequencies divided by a sum of values of the spectral characteristic. In view of the fact that in real the spectral characteristic may be stored as an array, array indexes may be taken instead of frequencies, and then the derived quotient may be reduced to an integral index, so a relevant value of frequency may be taken. In other words, the median of the spectrum is a weighted mean value of the spectral characteristic wherein frequencies are weights.

To compute the width of the spectrum it is necessary to give a some threshold value, below which the spectral characteristic is considered to be conditionally zero (in this case, based on statistics, we have taken 5%-threshold). A difference between maximal and minimal frequencies for which the spectral characteristic exceeds this threshold is taken as a width of the spectrum.

Furthermore, when a memory device (RAM) has previous computed data for four initial parameters of the spectrum on a basis of some previous data block, the previous data are updated (step 350).

Furthermore, when performing the step 360, four stress factors that meet every of the four initial parameters are computed on a basis of the updated values of the four initial parameters of the spectrum by the formula:

Z=(M−P)/M+(L−P)/L,
wherein M—an arithmetic mean value of a relevant initial parameter,
   L—a local mean value of the relevant initial parameter,
   P—a current value of the relevant initial parameter.

At that, the local mean value is computed as follows.

When there is one datum only, it is assumed that L=P, because there is nothing to compare with the only one datum.

In case of a boundary datum, when implying that there is the only previous and the only subsequent value of the initial parameter, as usually takes place in computing in a real-time mode, when, under understood reasons, there is no any subsequent value, computation is made by the formula:

L=(2·P+Pₒᵤₜ)/3,
wherein Pₒᵤₜ—a neighboring value of the parameter with a boundary value (for example, previous one).

In case of an internal datum by which is implied that there both a previous and subsequent values of the initial parameter, computation is made by the formula:

L=(P₋+2·P+P₊)/4,
wherein P₋—a previous value of a parameter,
   P₊—a subsequent value of the parameter.

Thus, after performing the step 360, the four dimensionless stress factors are derived, which are used in beginning of the step 370 to compute four dimensionless normalized stress parameters showing a stress state by a relevant parameter of the spectrum by the formula:

Stress=1/(1+e^{Z}).

The derived normalized Stress value is always from 0 to 1 and approaching zero when the stress factor approaches the plus perpetuity or a unity when the stress factor approaches the minus perpetuity. Thus, the normalized stress factor is monotonously decreasing with increasing the stress factor. In principle, every of the four normalized Stress values can be used to identify a level of a stress state in accordance with a value of this dimensionless parameter, however, for considerable increasing an accuracy of a result, when performing the step 370, an integral dimensionless parameter Stress_{Σ} is computed, which rather accurately shows both the presence of a stress state and a level of a stress state as a weighted mean value of the all four derived normalized stress parameters. As studies demonstrated, an arithmetic mean value may be used as the weighted mean value in this case.

Furthermore, when performing the step 380, commands are formed for outputting by the display unit 4 of the results computed by the processing unit 3. In so doing, a nature of the commands depends on the computed value of Stress_{Σ}. At that, since a value of Stress_{Σ} is also within from 0 to 1, when a value of Stress_{Σ} is approximately equal to zero it is commanded to display an absence of a stress, and when a value of Stress_{Σ} is approximately equal to unit it is commanded to display a presence of a strong stress, and in case of intermediate values of a stress it is commanded to display a stress state in proportion to the value of Stress_{Σ}.

Furthermore, the processing unit 3 receives a next data block of the voice signal in a digital form from the receiving unit 2, if any, and the steps 320-380 are repeated for this data block.

For example, let take some data block of a voice signal for some time T (the step 320). FTF, an intensity of the spectrum, a median of the spectrum and a width of the spectrum are computed by any well-know method, e.g. by the Fourier's transformation. As result, we can obtain values shown in a column P(i) in a table as below:

| | Accumulated | | | | | | |
|---|---|---|---|---|---|---|---|
| | mean value | | | | | | |
| Parameter | P_{m(1, i-1)} | P₍ᵢ₋₁₎ | P₍ᵢ₎ | L | M | Z | Stress |
| FTP (Hz) | 190 | 185 | 183 | 183.66 | 189.986 | 0.040401 | 0.48990 |
| Median (dB) | 55 | 50 | 46 | 47.33 | 54.982 | 0.191532 | 0.45226 |
| Intensity (dB) | 61 | 60 | 54 | 56 | 60.986 | 0.150265 | 0.46250 |
| Width (Hz) | 15 | 20 | 18 | 18.66 | 15.006 | −0.16381 | 0.54086 |

For the operation 360, it necessary to use values of L and M.

The mean arithmetic value M for each parameters is computing as:

M=(P_{m(1, i-1)}·P₍ᵢ₋₁₎+Pᵢ)/i,

for example, a value for FTF on the 500-th window is: M=(190·499+183)/500=189,986.

The local mean value L is computing under a value of a corresponding parameter for adjacent time windows. As it was mentioned above, such two windows are overlapping by a half of its width, i.e. if the time T is divided into intervals of 10 ms, values of the parameters of the previous window P₍ᵢ₋₁₎ have to be considered for the previous step by taking that window that is beginning before on 5 ms as:

L=(Pᵢ·2+P₍ᵢ₋₁₎/3,

for example, a value for FTF is: L=(183·2+185)/3=183.66.

Then, the stress factor is computing as Z=(M−Pᵢ)/M+(L−Pᵢ)/L ,

for example, a value for FTF is: Z=(189.986−183)/189.986+(183.66−183)/183.66=0.040.

Obtained stress factor is normalized for each parameters during the step 370:

Stress=1/(1+e^{Z}),

for example, a value for FTF is: Stress=1/(1+e^{0.04})=0.48990.

To complete computing the windows (the step 380) it is necessary to determine the integral dimensionless parameter Stress_{Σ} on a basis of all computed stress factors as their mean arithmetic value:

Stress_{Σ}=(0.48990+0.45226+0.46250+0.54086)/4=0.48638.

The obtained index which can be called as a medial stress is a usual state of a person. Suppose that for some moment of time there was obtained data as follows:

| | Accumulated | | | |
|---|---|---|---|---|
| | mean value | | | |
| Parameter | P_{m(1, i-1)} | P₍ᵢ₋₁₎ | P₍ᵢ₎ | Stress |
| FTF (Hz) | 190 | 280 | 300 | 0.6456 |
| Median (dB) | 55 | 71 | 72 | 0.5776 |
| Intensity (dB) | 61 | 82 | 82 | 0.5850 |
| Width (Hz) | 15 | 45 | 70 | 0.9774 |
| Stress_{Σ} | | | | 0.6964 |

This new index Stress_{Σ} illustrates that a stress is increased. Other words, as far as current parameters differ from medial ones, the stress is more thereby.

The display unit 4 for displaying of the results of a stress state received by the processing unit 3 is intended for displaying a current level of a stress state both by direct displaying a value of Stress_{Σ} and by displaying various signals that correspond to a value of Stress_{Σ} or certain values intervals of Stress_{Σ}. At that, the display unit 4 can be implemented as any built-in peripheral device capable for displaying the results as graphical, light or other information. A further example will demonstrate some embodiments of displaying various signals.

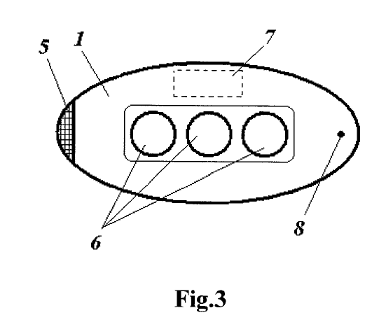

FIG. 3 gives a schematic view of one embodiment of the present invention as a separate portable stress detector by voice that can be used as a trinket or a pendent.

In this embodiment, a portable stress detector 1 includes the above-mentioned units 2-4 implemented on a microprocessor basis, in so doing, the receiving unit 2 includes a microphone 5, the display unit includes a three-color light panel with three light-emitting diodes 6 of red, yellow and green colors respectively which are arranged in order as traffic lights and a vibrator 7 implemented as a piezoelement which is similar to vibrators used in vibration calls or vibration melodies in common mobile telephones. The units 2-4 operate in the same manner as described above, at that there are two embodiments of displaying the obtained results that may be used jointly or separately.

In the embodiment of displaying by optical emission only, one of the light-emitting diodes 6 glows depending on a current value of Stress_{Σ} computed by the processing unit 3 in accordance with following. When Stress_{Σ}=0.0-0.3, the green light-emitting diode glows that meets an absence or a small value of the stress state, including excitement, which bears witness to sufficient honesty of utterances taken by the microphone 5. When Stress_{Σ}=0.3-0.7, the yellow light-emitting diode glows that meets an absence or a small value of the stress state, which bear witness to excitement of utterances taken by the microphone 5, at that, honesty of utterance is rather doubtful. When Stress_{Σ}=0.7-1.0, the red light-emitting diode glows that meets to a large value of the stress state, which bears witness to the extreme level of excitement of a speech taken by the microphone 5, at that utterances are most likely dishonest. Such light signals, similar to traffic lights, are rather easily recognized by a user.

In the embodiment of displaying by vibration, the vibrator 7 does not vibrate when Stress_{Σ} is less than 0.1 and then it becomes to vibrate with minimum frequency of vibrations amongst from possible ones for the vibrator 7 when Stress_{Σ}=0.1 with proportional increasing frequency of the vibrations due to increasing a value of Stress_{Σ} with maximum of such frequency when Stress_{Σ} is approximately equal or equal to unity.

It should be obvious that the proposed device is rather simple from a software standpoint and may be united with known computerized devices, which process sound signals such as a digital dictophone, a cellular telephone, a digital sound-recording camera, a palm-size computer.

The given examples are used only for illustrating some embodiments of this invention and in no way restricts a scope of legal protection presented in the claims, at that, a specialist in this art is rather simply capable of take other steps for another embodiment of the invention.

1-25. (canceled)

26. A method for determining a stress state of a person according to a voice including following steps:
receiving a voice signal in a certain time interval;
computation of spectral characteristics of the received voice signal;
determining a level of a stress state according to the computed spectral characteristics; and
displaying results of determined stress state,
wherein:
when computing the spectral characteristics, at least four parameters of a spectrum of the received voice signal are computed: a base frequency, an intensity of the spectrum, a median of the spectrum and a width of the spectrum;
when determining the level of a stress state, a dimensionless normalized stress parameter is computed for every of the four parameters, wherein said dimensionless normalized stress parameter reflects the stress state for each of the parameters of the spectrum and is computed on a base of a stress factor Z of the normalized stress parameter, which is preliminary computed as a sum of relative deviations between an arithmetic mean value of the parameter and a current value of the parameter and between a local mean value of the parameter and the current value of the parameter, then a normalized stress parameter is computed as 1/(1+e^{Z}), and a value of the level of a stress state is determined as a weighted mean value of all computed normalized stress parameters; and
the results of the determined stress state are displaying by direct displaying the value of the level of a stress state and/or by displaying signals that correspond to the value of the level of a stress state or certain values intervals of the level of a stress state.

27. The method of claim 26, wherein voice signal windows overlapping at least by a half of a width thereof are used for the computation of the spectral characteristics.

28. The method of claim 27, wherein the voice signal windows are taken for the computation in condition that there are not more than one non-vocalized voice signal window in a row of the taken voice signal windows.

29. The method of claim 27, wherein the voice signal windows are taken for the computation in condition that a relative deviation of the base frequency in any couple of vocalized voice signal windows does not exceed 20%.

30. The method of claim 26, wherein the base frequency at a maximum of the spectral characteristic in a frequency range of 50-500 Hz is taken as a current value of the base frequency.

31. The method of claim 26, wherein the intensity of the spectrum is computed as an integral of a square of the spectral characteristic.

32. The method of claim 26, wherein the median of the spectrum is computed as a weighted mean value of the spectral characteristic, wherein frequencies are used as weights.

33. The method of claim 26, wherein the width of the spectrum is computed as a difference between maximum and minimum frequencies for which the spectral characteristic exceeds a preset threshold value.

34. The method of claim 33, wherein when computing the width of the spectrum, the threshold value is preset as 2-8% below of which the spectral characteristic is considered as to be zero.

35. The method of claim 26, wherein the weighted mean value of all computed normalized stress parameters is determined as an arithmetic mean value thereof.

36. The method of claim 26, wherein the results of the determined stress state are displayed by optical emission in a range of visible waves, wherein a length of an emitted light wave depends on a value of the determined level of a stress state.

37. The method of claim 36, wherein the determined level of the stress state is displayed so that the length of the emitted light wave increases or decreases in increasing or decreasing the value of the determined level of a stress state in a range of possible values thereof.

38. The method of claim 37, wherein a green light is used for the displaying minimal values of the level of a stress state, a yellow light is used for the displaying mean values of the level of a stress state, and a red light is used for the displaying the maximal values of the level of a stress state.

39. The method of claim 26, wherein the results of the determined stress state are displayed by vibration, wherein a frequency of the vibration depends on a value of the determined level of a stress state.

40. The method of claim 39, wherein the determined level of the stress state is displayed so that the a frequency of the vibration increases or decreases up to zero in increasing or decreasing the value of the determined level of a stress state in a range of possible values thereof.

41. The method of claim 40, wherein a minimal frequency of the vibration among possible values thereof or an absence of the vibration is used for the displaying minimal values of the level of a stress state, a mean frequency of the vibration among the possible values thereof is used for the displaying mean values of the level of a stress state, and a maximal frequency of the vibration among the possible values thereof is used for the displaying maximum values of the level of a stress state.

42. A device for determining a stress state of a person according to a voice including:
a receiving unit for receiving a voice signal in a certain time interval;
a processing unit for computation of spectral characteristics of a spectrum of the received voice signal converted into a digital form and determining a level of a stress state according to the computed spectral characteristics; and
a display unit for displaying results of a determined stress state, wherein the processing unit is fulfilled with possibilities to compute the spectral characteristics of the spectrum of the received voice signal and to determine the level of a stress state according to the computed spectral characteristics by the method of claims 26.

43. The device of claim 42, wherein the display unit is an optical emission means for emitting a light in a range of visible waves, wherein a length of an emitting light wave depends on a value of the level of a stress state determined by the processing unit.

44. The device of claim 43, wherein the optical emission means has possibility to emit a green light when the level of a stress state has minimal values among possible values of the level of a stress state, a yellow light for mean values among the possible values of the level of a stress state, and a red light for maximal values among possible values of the level of a stress state.

45. The device of claim 41, wherein the display unit is a vibration means, wherein a frequency of vibrations depends on the level of a stress state determined by the processing unit.

46. The device of claim 45, wherein the vibration means has possibility to vibrate with a minimal frequency of a vibration up to zero among possible values thereof for the vibration means when the level of a stress state has minimal values among possible ones, to vibrate with mean frequencies of the vibrations among the possible values thereof for the vibration means when the level of a stress state has mean values of the possible values among possible ones, and to vibrate with maximal frequencies of the vibration among the possible values thereof for the vibration means when the level of a stress state has maximum values among possible ones.

47. The device of claim 41, wherein all units of the device are combined into a single portable device.

48. The device of claim 41, wherein all units of the device are incorporated into a computer or a computerized device.

49. The device of claim 48, wherein the computerized device is selected from a group: a digital dictophone; a cellular telephone; a digital sound-recording camera; a palm-size computer.
